(19) United States
(12) Patent Application Publication
(10) Pub. No.: US 2021/0048501 A1
(43) Pub. Date: Feb. 18, 2021

(54) METHOD AND DEVICE FOR ESTIMATING AN ANGLE OF DEPARTURE

(71) Applicants: SHENZHEN FUTAIHONG PRECISION INDUSTRY CO., LTD., Shenzhen (CN); Chiun Mai Communication Systems, Inc., New Taipei (TW)

(72) Inventor: CHENG-NAN HU, New Taipei (TW)

(21) Appl. No.: 16/810,992

(22) Filed: Mar. 6, 2020

Related U.S. Application Data
(60) Provisional application No. 62/885,379, filed on Aug. 12, 2019.

(51) Int. Cl. G01S 3/36

(52) U.S. Cl. CPC G01S 3/36

(57) ABSTRACT

A transmitting device and a receiving device, which can carry out measurements, are disclosed together with a method for estimating an angle of departure of radio waves. The receiving device sets an equal phase of each antenna in a uniform circular array antenna, receives a transmitted millimeter wave signal, and calculates angle of arrival (AOD) of the millimeter wave signal, thus simplifying the steps for estimating AOD.

### CROSS-REFERENCE TO RELATED APPLICATIONS

This application claims priority to U.S. provisional Patent Application No. 62/885379 filed on Aug. 12, 2019, the contents of which are incorporated by reference herein.

### FIELD

The subject matter herein generally relates to wireless communications.

### BACKGROUND

Known methods for measuring angles of departure (AOD) of millimeter wave signals may be complicated. A device for estimating AOD may be expensive.

### BRIEF DESCRIPTION OF THE DRAWINGS

Implementations of the present disclosure will now be described, by way of embodiments, with reference to the attached figures.

FIG. 1 is a block diagram of one embodiment of an environment in which a method for estimating an angle of departure of millimeter wave signal is applied.

FIG. 2 is a block diagram of an embodiment of a device for estimating an angle of departure of FIG. 1.

FIG. 3 is a structural schematic of the device for estimating an angle of departure of wave signal of FIG. 2.

FIG. 4 is a structural schematic of a uniform circular array antenna.

FIG. 5 is a block diagram of an embodiment of a measurement device.

FIG. 6 illustrates a block diagram of a system for estimating an angle of departure.

FIG. 7 illustrates a flowchart of one embodiment of a method for estimating an angle of departure of millimeter wave signal.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. In addition, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means, “including, but not necessarily limited to”; it specifically indicates open-ended inclusion or membership in a so-described combination, group, series, and the like.

Exemplary embodiments of the present disclosure will be described in relation to the accompanying drawings.

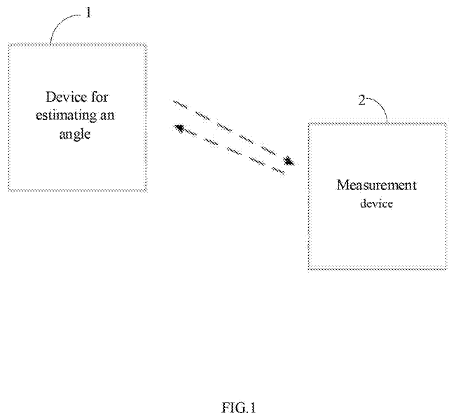

FIG. 1 illustrates an embodiment of a running environment of a method for estimating an angle of departure of a millimeter wave signal. The method runs in a device 1 for estimating an angle of departure, and in a measurement device 2. The device 1 for estimating an angle of departure communicates with the measurement device 2 by a wireless signal, for example, the wireless signal can be a millimeter wave signal. In one embodiment, the device 1 has effectively the same structure as the measurement device 2. In another embodiment, the device 1 and the measurement device 2 have different structures. In one embodiment, the device 1 can be a millimeter wave base-station, and the measurement device 2 can be a mobile device such as a mobile phone. In another embodiment, the device 1 and the measurement device 2 are millimeter wave base stations or mobile devices.

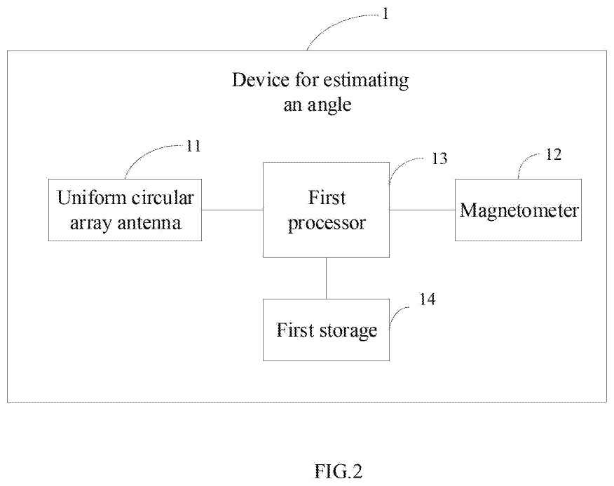

FIG. 2 illustrates the device 1 for estimating an angle of departure of FIG. 1. The device 1 includes a uniform circular array antenna 11, a magnetometer 12, a first processor 13, and a first storage 14. The uniform circular array antenna 11 communicates with the measurement device 2. In one embodiment, the uniform circular array antenna 11 is a round antenna array formed by a number of antennas. The magnetometer 12 is used to measure an azimuth of the device 1. In one embodiment, the magnetometer 12 measures a positive north direction of the device 1 and regards the north direction as the azimuth (such as AOD or AOA) of the device 1. The azimuth of the device 1 measured by the magnetometer 12 is not limited to being due north; the azimuth of the device 1 can also be taken from a positive south direction, a positive east direction, or a positive west direction.

In one embodiment, the first processor 13 controls the device 1 to receive a millimeter wave signal through the uniform circular array antenna 11, and estimate the angle of departure from its source of the millimeter wave signal. In one embodiment, the first processor 13 is configured to execute program instructions installed in the device 1 and control the device 1 to execute actions. In at least one embodiment, the first processor 13 can be a central processing unit (CPU), a microprocessor, a digital signal processor, an application processor, a modem processor, or a processor with an application processor and a modem processor integrated inside. In one embodiment, the first storage 14 stores the data and program instructions installed in the device 1. For example, the first storage 14 can be an internal storage system, such as a flash memory, a random access memory (RAM) for temporary storage of information, and/or a read-only memory (ROM) for permanent storage of information. In another embodiment, the first storage device 14 can also be an external storage system, such as a hard disk, a storage card, or a data storage medium. The first processor 14 is configured to execute program instructions installed in the device 1 and control the device 1 to execute actions.

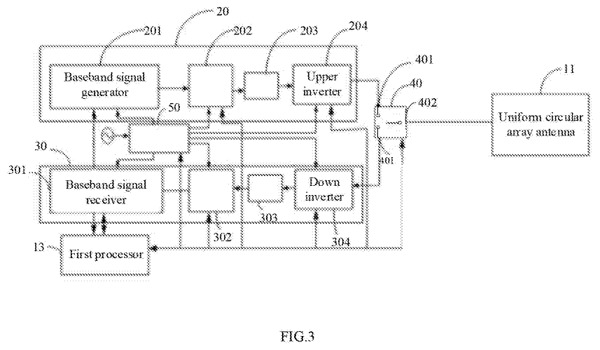

FIG. 3 illustrates the device 1. The device 1 includes a transmitter 20, a receiver 30, a switch module 40, and an oscillator 50 with a lock-phase circuit. The switch module 40 includes two first inputs 401 and one first output 402. The two first inputs 401 in the switch module 40 connect to the first output 402. The transmitter 20 and the receiver 30 connect to the two first inputs 401 of the switch module 40. The first output 402 of the switch module 40 connects to the uniform circular array antenna 11. The oscillator 50 connects to the transmitter 20 and the receiver 30, and provides local carriers for the transmitter 20 and the receiver 30.

In one embodiment, the transmitter 20 includes a baseband signal generator 201, a first intermediate frequency converter 202, a first band pass filter 203, and an upper inverter 204. The baseband signal generator 201 connects to the first intermediate frequency converter 202. The first intermediate frequency converter 202 connects to the first band pass filter 203. The first band pass filter 203 connects to the upper inverter 204. The upper inverter 204 connects to the first input 401 of the switch module 40. The first output 402 of the switch module 40 connects to the uniform circular array antenna 11. In one embodiment, the baseband signal generator 201 generates a baseband signal. The first intermediate frequency converter 202 converts the generated baseband signal to an intermediate frequency signal. In one embodiment, the bandwidth of the intermediate frequency signal may be 2.4 GHz. The first band pass filter 203 is used to filter the intermediate frequency signal. In one embodiment, the bandwidth of the first band pass filter 203 is 2.4 to 2.4835 GHz. The upper inverter 204 converts the intermediate frequency signal to a target frequency signal, which can be a millimeter wave signal. The target frequency signal is transmitted by the switch module 40 and is sent by the uniform circular array antenna 11. The oscillator 50 connects to the baseband signal generator 201, the first intermediate frequency converter 202, and the upper inverter 204, and provides local carriers for the baseband signal generator 201, the first intermediate frequency converter 202, and the upper inverter 204.

In one embodiment, the receiver 30 includes a baseband signal receiver 301, a second intermediate frequency converter 302, a second band pass filter 303, and a down inverter 304. The baseband signal receiver 301 connects to the second intermediate frequency converter 302. The second intermediate frequency converter 302 connects to the second band pass filter 303, and the second band pass filter 303 connects to the down inverter 304. The down inverter 304 connects to the first input 401 of the switch module 40. In one embodiment, the uniform circular array antenna 11 receives the millimeter wave signal, and transmits the uniform circular array antenna 11 through the switch module 40 to the down inverter 304. The down inverter 304 converts the millimeter wave signal to an intermediate frequency signal. The intermediate frequency signal is filtered by the second band pass filter 303 and is converted by the second intermediate frequency converter 302 to obtain a baseband signal. The baseband signal is transmitted to the baseband signal receiver 301. In one embodiment, the bandwidth of the second band pass filter 303 is 2.4 to 2.4835 GHz. In one embodiment, the baseband signal is a chirp signal. The bandwidth of the baseband signal can be 400 KHz, 1.6 MHz, 20 MHz, 80 MHz, or 500 MHz. In one embodiment, the oscillator 50 connects to the baseband signal receiver 301, the second intermediate frequency converter 302, and the down inverter 304, and provides local carriers for the baseband signal receiver 301, the second intermediate frequency converter 302, and the down inverter 304. In one embodiment, the first processor 13 connects to the baseband signal generator 201, the baseband signal receiver 301, the oscillator 50, the first intermediate frequency converter 202, the second intermediate frequency converter 302, the upper inverter 204, the down inverter 304, the switch module 40, and the uniform circular array antenna 11.

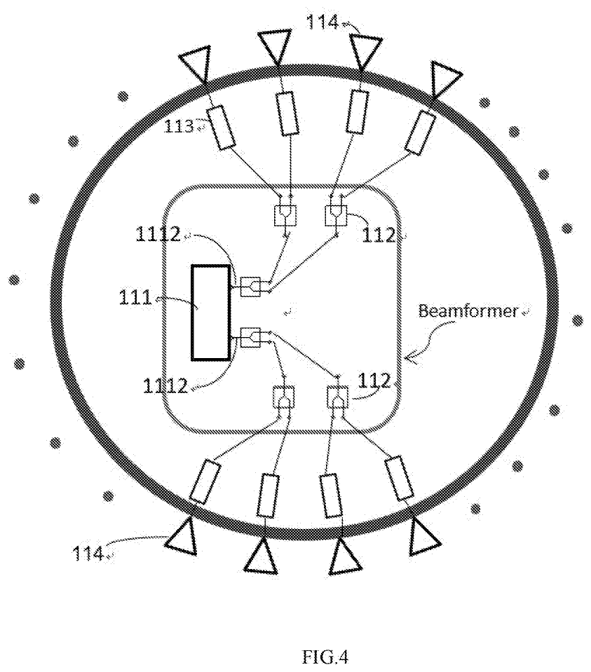

FIG. 4 illustrates the uniform circular array antenna 11. The uniform circular array antenna 11 includes a magic tee coupler 111, a number of power dividers 112, a number of transceivers 113, and a number of antennas 114. In one embodiment, the quantities of power dividers 112 and transceivers 113 can be determined according to the quantity of the antennas 114. In one embodiment, the quantity of the antennas 114 and the quantity of the transceivers 113 are N, N=2n, and the quantity of the power dividers 112 is S, S=2ⁿ⁻¹+2ⁿ⁻², where n is a positive integer greater than 2. In one embodiment, the magic tee coupler 111 includes two second inputs (not shown) and two second outputs 1112. The first output 402 of the switch module 40 connects to one of two second inputs of the magic tee coupler 111, and the other second input of the magic tee coupler 111 connects to the down inverter 304. The two second outputs of the magic tee coupler 111 connect to the transceivers 113 through the power dividers 112, and each transceiver 113 connects to one antenna 114.

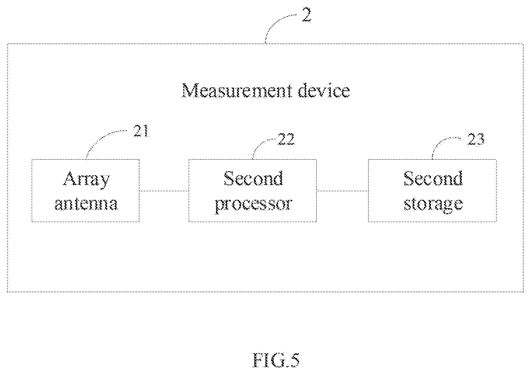

FIG. 5 illustrates an embodiment of the measurement device 2. In one embodiment, the measurement device 2 includes an array antenna 21, a second processor 22, and a second storage 23. The array antenna 21 is used to receive and transmit the millimeter signal. In one embodiment, second processor 22 is configured to execute program instructions installed in the measurement device 2 and control the measurement device 2 to execute orders or actions. In at least one embodiment, the second processor 22 can be a CPU, a microprocessor, a digital signal processor, an application processor, a modem processor, or a processor with an application processor and a modem processor integrated inside. In one embodiment, the second storage 23 is configured to store the data and program instructions installed in the measurement device 2. For example, the second storage 23 can be an internal storage system, such as a flash memory, a RAM for temporary storage of information, and/or a ROM for permanent storage of information. In another embodiment, the second storage 23 can also be an external storage system, such as a hard disk, a storage card, or a data storage medium.

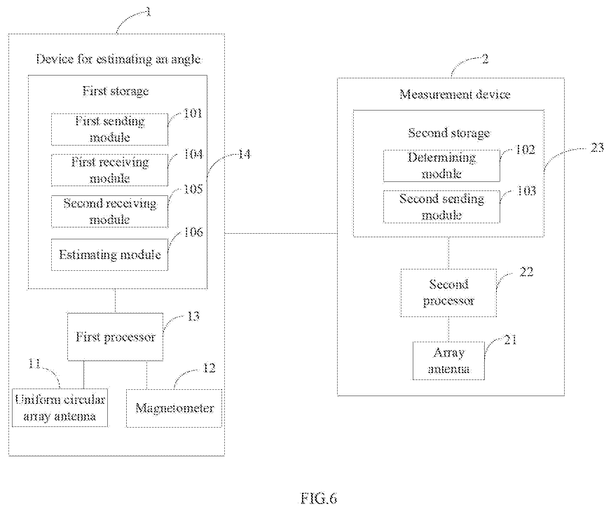

FIG. 6 illustrates an embodiment of a system for estimating an angle of departure of radio waves. In one embodiment, the system includes one or more modules, the one or more modules being applied in the device 1 for estimating an angle of departure and the measurement device 2. In one embodiment, the system includes a first sending module 101, a determining module 102, a second sending module 103, a first receiving module 104, a second receiving module 105, and an estimating module 106. In one embodiment, the modules of the system can be collections of software instructions. The first sending module 101, the first receiving module 104, the second receiving module 105, and the estimating module 106, are stored in the first storage 14 of the device 1 and executed by the first processor 13 of the device 1. The determining module 102 and the second sending module 103 are stored in the second storage 23 of the measurement device 2 and executed by the second processor 22 of the measurement device 2. In another embodiment, the first sending module 101, the first receiving module 104, the second receiving module 105, and the estimating module 106 are a program segment or code embedded in the first processor 13 of the device 1, and the determining module 102 and the second sending module 103 are a program segment or code embedded in the second processor 22 of the measurement device 2.

The first sending module 101 sets to the same value a phase of each antenna 114 in the uniform circular array antenna 11, and the uniform circular array antenna 11 thus can function as an omnidirectional antenna and the millimeter wave signals are sent to the measurement device 2 by the omnidirectional antenna.

In one embodiment, the first sending module 101 sets to the same value a phase of each antenna 114 in the uniform circular array antenna 11, the phases of antennas 114 in the uniform circular array antenna 11 are thus distributed evenly. Such antennas 114 in the uniform circular array antenna 11 thus form the omnidirectional antenna. The first sending module 101 sends the millimeter wave signal to the measurement device by the omnidirectional antenna. In one embodiment, the first sending module 101 sets to zero degrees the phases of the antennas 114 in the uniform circular array antenna 11 to make the uniform circular array antenna 11 form the omnidirectional antenna. In another embodiment, the first sending module 101 can control the phase setting of a radiation signal to make the uniform circular array antenna 11 form the omnidirectional, sum, and different radiation pattern.

The determining module 102 controls the array antenna 21 to receive the millimeter signal sent by the device 1, and determines a first angle of arrival (AOA) of the millimeter wave signal according to a received signal strength indication (RSSI) of the millimeter wave signal.

In one embodiment, the array antenna 21 of the measurement device 2 has four sectors, and each sector of the four sectors has at least one sector antenna. The determining module 102 controls the sector antennas in the four sectors of the array antenna 21 to scan and receive the millimeter wave signal sent by the device 1 at different AOAs. The determining module 102 determines an AOA of the millimeter wave signal as a first AOA when the signal strength or the RSSI of the millimeter wave signal corresponding to the AOA exceeds the signal strength threshold. In one embodiment, the determining module 102 controls the sector antennas of the four sectors to scan within a preset cycle and to receive the millimeter wave signal sent by the device 1 at different AOAs of the beam through the sector antennas. In one embodiment, the sector antennas of the four sectors respectively scan and receive the millimeter wave sent by the device 1 at zero to 90 degrees, 90 to 180 degrees, 180 to 270 degrees, and 270 to 360 degrees. In one embodiment, the sector antenna has a 1×16 or 1×8 antenna structure.

In one embodiment, the array antenna 21 has three sectors, each sector of the three sectors having a sector antenna. The determining module 102 controls the sector antenna in the three sectors of the array antenna 21 in the measurement device 2 to scan and receive the millimeter wave signal sent by the device 1 at different AOAs. In one embodiment, the determining module 102 controls the sector antennas of the three sectors to scan within the preset cycle and to receive the millimeter wave signal sent by the device 1 at different AOAs of the beam through the sector antenna. In one embodiment, the sector antennas of the three sectors respectively scan and receive the millimeter wave sent by the device 1 at zero to 120 degrees, 120 to 240 degrees, and 240 to 360 degrees. In one embodiment, the measurement device determines an AOA of the millimeter wave signal as the first AOA when the signal strength or the RSSI of the millimeter wave signal corresponding to the AOA exceeds the signal strength threshold.

The second sending module 103 controls the array antenna 21 to send the millimeter wave signal at the first AOA to the device 1.

The first receiving module 104 sets the phase of each antenna 114 in the uniform circular array antenna 11 to form a first antenna according to formula ψᵢ=k₀[xᵢ sin (θₛ) cos (φₛ)+yᵢ sin (θₛ) sin (φₛ)]. The millimeter wave signal is received by the first antenna, and a first signal power of the millimeter wave signal is determined and the first signal power is the first signal of a sum pattern, where i=1, 2, . . . , N, N is the quantity of the antennas 114 of the uniform circular array antenna 11, is a phase of the ith antenna 114 of the uniform circular array antenna 11, xᵢ is a coordinate of a horizontal axis corresponding to the ith antenna 114 of the uniform circular array antenna 11, yᵢ is a coordinate of a vertical axis corresponding to the ith antenna 114 of the uniform circular array antenna 11, and θs and ϕs are azimuths of beam of the millimeter wave signal received by the device 1. In another embodiment, θs is azimuth of beam of the millimeter wave signal, and ϕs is elevation of beam of the millimeter wave signal. In one embodiment, a two-dimensional rectangular coordinate system is constructed by setting a center point of the uniform circular array antenna 11 as a point of origin, and the vertical axis and the horizontal axis are set based on the origin point.

The second receiving module 105 sets the phase of each antenna 114 in the uniform circular array antenna 11 to form a second antenna according to formula ψᵢ=k₀[xᵢ sin (θₛ) cos (φₛ)+yᵢ sin (θₛ) sin (φₛ)], i=1, 2, . . . , N/2, and formula ψᵢ=−k₀[xᵢ sin (θₛ) cos (φₛ)+yᵢ sin (θₛ) sin (ϕₛ)], i=N/2+1, N/2+2, . . . , N. The millimeter wave signal is acquired by the second antenna, and second signal power of the millimeter wave signal is determined and the second signal power is the second signal of a different pattern, where i=1, 2, . . . , N, N is the quantity of the antennas 114 of the uniform circular array antenna 11, is a phase of the ith antenna 114 of the uniform circular array antenna 11, xi is the coordinate of a horizontal axis corresponding to the ith antenna 114 of the uniform circular array antenna 11, yi is the coordinate of a vertical axis corresponding to the ith antenna 114 of the uniform circular array antenna 11, and θs and ϕs are azimuths of beam of the millimeter wave signal.

The estimating module 106 calculates an AOD of the millimeter wave signal according to formula

$${θ}_{AOD} = {tan}^{- 1} ( k \frac{{r}_{SUM}}{{r}_{DIF}} ) ,$$

where r_{SUM} is the first signal of the sum pattern, r_{DIF} is the second signal of the different pattern,

$$k = {G}_{ratio} \frac{λ}{2 π d} ,$$

Gᵣₐₜᵢₒ is a ratio of the first signal power to the second signal power or a peak power ratio of the first signal power to the second signal power, λ is a wavelength of the millimeter wave signal received by the device 1, and d is a spacing between adjacent antennas in the uniform circular array antenna 11. In one embodiment, the first antenna and the second antenna are array antennas.

In the present disclosure, the device 1 sets the phase of each antenna 114 in the uniform circular array antenna 11, receives the millimeter wave signal sent by the measurement device 2 through the phases of antennas 114 in the uniform circular array antenna 11, and calculates AOD of the millimeter wave signal. The steps of estimation of AOD measurement are thus simplified.

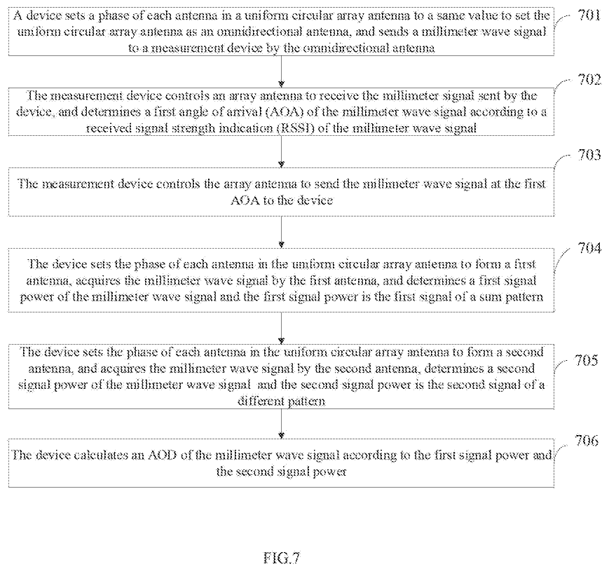

FIG. 7 illustrates a flowchart of one embodiment of a method for estimating an angle of departure of millimeter wave signal. The method is provided by way of example, as there are a variety of ways to carry out the method. The method described below can be carried out using the configurations illustrated in FIGS. 1-6, for example, and various elements of these figures are referenced in explaining the example method. Each block shown in FIG. 7 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 701.

At block 701, a device for estimating an angle of departure sets a phase of each antenna in a uniform circular array antenna to a same value, setting the uniform circular array antenna as an omnidirectional antenna, and sends a millimeter wave signal to a measurement device through the omnidirectional antenna.

In one embodiment, the transmitting device sets a phase of each antenna in the uniform circular array antenna to a same value, thus the phases of antennas in the uniform circular array antenna are distributed evenly. The antennas in the uniform circular array antenna with the same phase value form the omnidirectional antenna. The transmitting device sends the millimeter wave signal to the measurement device by the omnidirectional antenna. In one embodiment, the phases of the antennas can all be set at zero degrees to make the uniform circular array antenna form the omnidirectional antenna. In another embodiment, the device can control the phase setting of a radiation signal to make the uniform circular array antenna form the omnidirectional, sum, and different radiation patterns.

At block 702, the measurement device controls an array antenna to receive the millimeter signal sent by the transmitting device, and determines a first angle of arrival (AOA) of the millimeter wave signal according to a received signal strength indication (RSSI) of the millimeter wave signal.

In one embodiment, the array antenna of the measurement device has four sectors, and each sector of the four sectors has at least one sector antenna. The measurement device controls the sector antennas in the four sectors of the array antenna to scan and receive the millimeter wave signal at different AOAs. The measurement device determines an AOA of the millimeter wave signal as a first AOA when the signal strength or the RSSI of the millimeter wave signal corresponding to the AOA exceeds the signal strength threshold. In one embodiment, the measurement device controls the sector antennas of the four sectors to scan within a preset cycle and to receive the millimeter wave signal sent by the device at different AOAs. In one embodiment, the sector antennas of the four sectors respectively scan and receive the millimeter wave sent by the device at zero to 90 degrees, 90 to 180 degrees, 180 to 270 degrees, and 270 to 360 degrees. In one embodiment, the sector antenna has a 1×16 or 1×8 antenna structure.

In one embodiment, the array antenna has three sectors, and each sector of the three sectors has one sector antenna. The measurement device controls the sector antenna in the three sectors of the array antenna in the measurement device to scan and receive the millimeter wave signal sent at different AOAs. In one embodiment, the measurement device controls the sector antennas of the three sectors to scan within the preset cycle and to receive the millimeter wave signal at different AOAs of the beam through the sector antenna. In one embodiment, the sector antennas of the three sectors respectively scan and receive the millimeter wave sent by the device at zero to 120 degrees, 120 to 240 degrees, and 240 to 360 degrees. In one embodiment, the measurement device determines an AOA of the millimeter wave signal as the first AOA when the signal strength or the RSSI of the millimeter wave signal corresponding to the AOA exceeds the signal strength threshold.

At block 703, the measurement device controls the array antenna to send the millimeter wave signal at the first AOA to the device.

At block 704, the device sets the phase of each antenna in the uniform circular array antenna to form a first antenna according to formula ψᵢ=k₀[xᵢ sin (θₛ) cos (φₛ)+yᵢ sin (θₛ) sin (φₛ)], acquires the millimeter wave signal through the first antenna, and determines a first signal power of the millimeter wave signal and the first signal power is the first signal of a sum pattern, wherein i=1, 2, . . . , N, N is the quantity of the antennas of the uniform circular array antenna, ψᵢ is a phase of the ith antenna 114 of the uniform circular array antenna, xi is a coordinate of a horizontal axis corresponding to the ith antenna of the uniform circular array antenna, yi is a coordinate of a vertical axis corresponding to the ith antenna of the uniform circular array antenna, and θs and ϕs are beam azimuths. In one embodiment, a two-dimensional rectangular coordinate system is constructed by setting a center point of the uniform circular array antenna as a point of origin, and setting the vertical axis and the horizontal axis based on the origin point.

At block 705, the device sets the phase of each antenna in the uniform circular array antenna to form a second antenna according to formula ψᵢ=k₀[xᵢ sin (θₛ) cos (φₛ)+yᵢ sin (θₛ) sin (φₛ)], i=1, 2, . . . , N/2, and formula ψᵢ=−k₀[xᵢ sin (θₛ) cos (φₛ)+yᵢ sin (θₛ) sin (φₛ)], i=N/2+1, N/2+2, . . . , N, and acquires the millimeter wave signal by the second antenna, determines a second signal power of the millimeter wave signal and the second signal power is the second signal of a different pattern, wherein N is the quantity of the antennas of the uniform circular array antenna, ψᵢ is a phase of the ith antenna of the uniform circular array antenna, xi is the coordinate of a horizontal axis corresponding to the ith antenna of the uniform circular array antenna, yi is the coordinate of a vertical axis corresponding to the ith antenna of the uniform circular array antenna, and Os and Os are azimuths of beam of the millimeter wave signal received by the device.

At block 706, the device calculates an AOD of the millimeter wave signal according to formula

$${θ}_{AOD} = {tan}^{- 1} ( k \frac{{r}_{SUM}}{{r}_{DIF}} ) ,$$

where r_{SUM} is the first signal of the sum pattern, r_{DIF} is the second signal of the different pattern,

$$k = {G}_{ratio} \frac{λ}{2 π d} ,$$

Gᵣₐₜᵢₒ is a ratio of the first signal to the second signal or a peak power ratio of the first signal power to the second signal power, λ is a wavelength of the millimeter wave signal received by the device, and d is a spacing between adjacent antennas in the uniform circular array antenna, thus simplifying the steps for estimating AOD.

The exemplary embodiments shown and described above are only examples. Even though numerous characteristics and advantages of the present disclosure have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A device for estimating an angle of departure comprising:
a uniform circular array antenna comprising:
a magic tee coupler;
a plurality of power dividers;
a plurality of transceivers; and
a plurality of antennas, wherein the magic tee coupler connects to the transceivers through the power dividers, and each of the transceivers connects to one of the antennas;
a processor connected to the magic tee coupler of the uniform circular array antenna; and
a non-transitory storage medium coupled to the processor and configured to store a plurality of instructions, which cause the device to:
receive a millimeter wave signal through the uniform circular array antenna, and estimate the angle of departure from the millimeter wave signal.

2. The device for estimating an angle of departure according to claim 1, wherein the plurality of instructions are further configured to cause the device to:
set a phase of each antenna in the uniform circular array antenna to a same value to set the uniform circular array antenna as an omnidirectional antenna, and send a millimeter wave signal to a measurement device by the uniform circular array antenna to make the measurement device determine a first angle of arrival;
set the phase of each antenna in the uniform circular array antenna to form a first antenna according to formula ψᵢ=k₀[xᵢ sin (θₛ) cos (φₛ)+yᵢ sin (θₛ) sin (φₛ)], i=1, 2, . . . , N, acquire the millimeter wave signal sent by the measurement device by the first antenna, and determine a first signal power of the millimeter wave signal and the first signal power is the first signal of a sum pattern;
set the phase of each antenna in the uniform circular array antenna to form a second antenna according to formula ψᵢ=k₀[xᵢ sin (θₛ) cos (φₛ)+yᵢ sin (θₛ) sin (φₛ)], i=1, 2, . . . , N/2, and formula ψᵢ=−k₀[xᵢ sin (θₛ) cos (φₛ)+yᵢ sin (θₛ) sin (ϕₛ)], i=N/2+1, N/2+2, N, acquire the millimeter wave signal by the second antenna, and determine a second signal power of the millimeter wave signal and the second signal power is the second signal of a different pattern, wherein N is the quantity of the antennas of the uniform circular array antenna, ψᵢ is a phase of the ith antenna of the uniform circular array antenna, xi is a coordinate of a horizontal axis corresponding to the ith antenna of the uniform circular array antenna, yi is a coordinate of a vertical axis corresponding to the ith antenna of the uniform circular array antenna, θs and ϕs are azimuths of beam of the millimeter wave signal received by the device; and
calculate the angle of departure (AOD) of the millimeter wave signal according to formula
$${θ}_{AOD} = {tan}^{- 1} ( k \frac{{r}_{SUM}}{{r}_{DIF}} ) ,$$
wherein r_{SUM} is the first signal of the sum pattern, r_{DIF} is the second signal of the different pattern;
$$k = {G}_{ratio} \frac{λ}{2 π d} ,$$
Gᵣₐₜᵢₒ is a ratio of the first signal to the second signal or a peak gain ratio of the first signal power to the second signal power, λ is a wavelength of the millimeter wave signal received by the device, d is a spacing between adjacent antennas in the uniform circular array antenna.

3. The device for estimating an angle of departure according to claim 2, wherein the plurality of instructions are further configured to cause the device to:
set the phases of the antennas in the uniform circular array antenna to 0°.

4. The device for estimating an angle of departure according to claim 2, wherein the plurality of instructions are further configured to cause the device to:
control the phases of the signal radiated/received by the uniform circular array antenna with specified phase setting to make the uniform circular array antenna form the omnidirectional, sum, and different radiation patterns based on the system requirement.

5. The device for estimating an angle of departure according to claim 2, wherein the device further comprises a transmitter, a receiver, a switch module, and an oscillator with a lock-phase circuit, the transmitter and the receiver connect to the switch module, the switch module connects to the uniform circular array antenna, the oscillator connects to the transmitter and the receiver, and provides local carriers for the transmitter and the receiver.

6. The device for estimating an angle of departure according to claim 5, wherein the transmitter comprises a baseband signal generator, a first intermediate frequency converter, a first band pass filter, and an upper inverter, the baseband signal generator connects to the first intermediate frequency converter, the first intermediate frequency converter connects to the first band pass filter, the first band pass filter connects to the upper inverter, the upper inverter connects to the first input of the switch module, the first output of the switch module connects to the uniform circular array antenna, the oscillator connects to the baseband signal generator, the first intermediate frequency converter, and the upper inverter, and provides local carriers for the baseband signal generator, the first intermediate frequency converter, and the upper inverter.

7. The device for estimating an angle of departure according to claim 6, wherein the receiver comprises a baseband signal receiver, a second intermediate frequency converter, a second band pass filter, and a down inverter, the baseband signal receiver connects to the second intermediate frequency converter, the second intermediate frequency converter connects to the second band pass filter, and the second band pass filter connects to the down inverter, the down inverter connects to the first input of the switch module, the oscillator connects to the baseband signal receiver, the second intermediate frequency converter, and the down inverter, and provides local carriers for the baseband signal receiver, the second intermediate frequency converter, and the down inverter.

8. The device for estimating an angle of departure according to claim 7, wherein the uniform circular array antenna further comprises a magic tee coupler, a plurality of power dividers, a plurality of transceivers, and a plurality of antennas, the magic tee coupler comprises two second inputs and two second outputs, the first output of the switch module connects to one of two second inputs of the magic tee coupler, and the other second inputs of the magic tee coupler connects to the down inverter, the two second outputs of the magic tee coupler connects to the transceivers by the plurality of the power dividers, and each of the transceivers connect to one of the plurality of antennas.

9. The device for estimating an angle of departure according to claim 8, wherein the quantity of the antennas and the quantity of the transceivers are N, N=2n, and the quantity of the power dividers 112 is S, S=2ⁿ⁻¹+2ⁿ⁻², wherein n is a positive integer greater than 2.

10. A method for estimating an angle of departure comprising:
setting a phase of each antenna in a uniform circular array antenna to a same value, and sending a millimeter wave signal to a measurement device by the uniform circular array antenna to make the measurement device determine a first angle of arrival (AOA);
setting the phase of each antenna in the uniform circular array antenna to form a first antenna according to formula ψᵢ=k₀[xᵢ sin (θₛ) cos (φₛ)+yᵢ sin (θₛ) sin (φₛ)], i=1, 2, . . . , N, acquiring the millimeter wave signal sent by the measurement device by the first antenna, and determining a first signal power of the millimeter wave signal, wherein the first signal power is the first signal of a sum pattern;
setting the phase of each antenna in the uniform circular array antenna to form a second antenna according to formula ψᵢ=k₀[xᵢ sin (θₛ) cos (φₛ)+yᵢ sin (θₛ) sin (φₛ)], i=1, 2, . . . , N/2, and formula ψᵢ=k₀[xᵢ sin (θₛ) cos (ϕₛ)+yᵢ sin (θₛ) sin (ϕₛ)], i=N/2+1, N/2+2, N, acquiring the millimeter wave signal by the second antenna, and determining a second signal power of the millimeter wave signal, wherein N is the quantity of the antennas of the uniform circular array antenna, is a phase of the ith antenna of the uniform circular array antenna, xi is a coordinate of a horizontal axis corresponding to the ith antenna of the uniform circular array antenna, yi is a coordinate of a vertical axis corresponding to the ith antenna of the uniform circular array antenna, θs and ϕs are azimuths of beam of the millimeter wave signal received by the device, the second signal power is the second signal of a different pattern; and calculating the angle of departure (AOD) of the millimeter wave signal according to formula
$${θ}_{AOD} = {tan}^{- 1} ( k \frac{{r}_{SUM}}{{r}_{DIF}} ) ,$$
wherein r_{SUM} is the first signal of the sum pattern, r_{DIF} is the second signal of the different pattern;
$$k = {G}_{ratio} \frac{λ}{2 π d} ,$$
Gᵣₐₜᵢₒ is a ratio of the first signal to the second signal or a peak gain ratio of the first signal power to the second signal power, λ is a wavelength of the millimeter wave signal received by the device, d is a spacing between adjacent antennas in the uniform circular array antenna.

11. The method according to claim 10 further comprising:
the measurement device controlling an array antenna to receive the millimeter signal sent by the device, and determining the first AOA of the millimeter wave signal according to a received signal strength indication (RSSI) of the millimeter wave signal; and
the measurement device controlling the array antenna to send the millimeter wave signal at the first AOA to the device.

12. The method according to claim 11 further comprising:
the measurement device controlling a plurality of sector antennas in four sectors of the array antenna to scan and receive the millimeter wave signal sent by the device at different AOAs, and determining an AOA of the millimeter wave signal as the first AOA when the signal strength or the RSSI of the millimeter wave signal corresponding to the AOA exceeds a signal strength threshold.

13. The method according to claim 12, wherein the sector antennas of the four sectors respectively scan and receive the millimeter wave sent by the device at 0 to 90 degrees, 90 to 180 degrees, 180 to 270 degrees, and 270 to 360 degrees.

14. The method according to claim 11 further comprising:
the measurement device controlling a plurality of sector antennas in three sectors of the array antenna in the measurement device to scan and receive the millimeter wave signal sent by the device at different AOAs; and
determining an AOA of the millimeter wave signal as the first AOA when the signal strength or the RSSI of the millimeter wave signal corresponding to the AOA exceeds a signal strength threshold.

15. The method according to claim 14, wherein the sector antennas of the three sectors respectively scan and receive the millimeter wave sent by the device at 0 to 120 degrees, 120 to 240 degrees, and 240 to 360 degrees.

16. A non-transitory storage medium having stored thereon instructions that, when executed by a processor of a device for estimating an angle of departure or a measurement device, causes the processor to execute instructions of a method for estimating an angle of departure, the method comprising:
setting a phase of each antenna in a uniform circular array antenna to a same value, and sending a millimeter wave signal to the measurement device by the uniform circular array antenna to make the measurement device determine a first angle of arrival (AOA);
setting the phase of each antenna in the uniform circular array antenna to form a first antenna according to formula ψᵢ=k₀[xᵢ sin (θₛ) cos (φₛ)+yᵢ sin (θₛ) sin (φₛ)], i=1, 2, . . . , N, acquiring the millimeter wave signal sent by the measurement device by the first antenna, and determining a first signal power of the millimeter wave signal, wherein the first signal power is the first signal of a sum pattern;
setting the phase of each antenna in the uniform circular array antenna to form a second antenna according to formula ψᵢ=k₀[xᵢ sin (θₛ) cos (φₛ)+yᵢ sin (θₛ) sin (φₛ)], i=1, 2, . . . , N/2, and formula ψᵢ=k₀[xᵢ sin (θₛ) cos (ϕₛ)+yᵢ sin (θₛ) sin (ϕₛ)], i=N/2+1, N/2+2, . . . N, acquiring the millimeter wave signal by the second antenna, and determining a second signal power of the millimeter wave signal, wherein N is the quantity of the antennas of the uniform circular array antenna, ψᵢ is a phase of the ith antenna of the uniform circular array antenna, xᵢ is a coordinate of a horizontal axis corresponding to the ith antenna of the uniform circular array antenna, yᵢ is a coordinate of a vertical axis corresponding to the ith antenna of the uniform circular array antenna, θs and ϕs are azimuths of beam of the millimeter wave signal received by the device, the second signal power is the second signal of a different pattern; and
calculating the angle of departure (AOD) of the millimeter wave signal according to formula
$${θ}_{AOD} = {tan}^{- 1} ( k \frac{{r}_{SUM}}{{r}_{DIF}} ) ,$$
wherein r_{SUM} is the first signal of the sum pattern, r_{DIF} is the second signal of the different pattern,
$$k = {G}_{ratio} \frac{λ}{2 π d} ,$$
Gᵣₐₜᵢₒ is a ratio of the first signal to the second signal or a peak gain ratio of the first signal power to the second signal power, λ is a wavelength of the millimeter wave signal received by the device, d is a spacing between adjacent antennas in the uniform circular array antenna.

17. The non-transitory storage medium according to claim 16, wherein the method is further comprising:
the measurement device controlling an array antenna to receive the millimeter signal sent by the device, and determining the first AOA of the millimeter wave signal according to a received signal strength indication (RSSI) of the millimeter wave signal; and
the measurement device controlling the array antenna to send the millimeter wave signal at the first AOA to the device.

18. The non-transitory storage medium according to claim 17, wherein the method is further comprising:
the measurement device controlling a plurality of sector antennas in four sectors of the array antenna to scan and receive the millimeter wave signal sent by the device at different AOAs, and determining an AOA of the millimeter wave signal as the first AOA when the signal strength or the RSSI of the millimeter wave signal corresponding to the AOA exceeds a signal strength threshold.

19. The non-transitory storage medium according to claim 18, wherein the sector antennas of the four sectors respectively scan and receive the millimeter wave sent by the device at 0 to 90 degrees, 90 to 180 degrees, 180 to 270 degrees, and 270 to 360 degrees.

20. The non-transitory storage medium according to claim 17 further comprising:
the measurement device controlling a plurality of sector antennas in three sectors of the array antenna in the measurement device to scan and receive the millimeter wave signal sent by the device at different AOAs; and
determining an AOA of the millimeter wave signal as the first AOA when the signal strength or the RSSI of the millimeter wave signal corresponding to the AOA exceeds a signal strength threshold.
